(19) United States
(12) Patent Application Publication
(10) Pub. No.: US 2012/0210770 A1
(43) Pub. Date: Aug. 23, 2012

(54) SYSTEMS AND METHODS FOR PERMEABILITY RATE TESTING OF BARRIER FILMS USING VAPOR ACCUMULATION

(76) Inventors: Aziz Mahfoud Familia, Shrewsbury, MA (US); David S. Shackleford, Framingham, MA (US); Eric L. Sheridan, Lexington, MA (US)

(21) Appl. No.: 13/217,524

(22) Filed: Aug. 25, 2011

Related U.S. Application Data
(60) Provisional application No. 61/381,827, filed on Sep. 10, 2010.

(51) Int. Cl. G01N 1/00

(52) U.S. Cl. 73/38

(57) ABSTRACT

The present invention is directed to systems and methods which utilize a cavity ringdown spectroscopy (CRDS) technique for measuring vapor transmission rate through a barrier film by first allowing the vapor to accumulate over a period of time after a steady state condition has been achieved. In this manner, in one embodiment, water permeation through a plastic film, even at very low permeability rates, can be accumulated over time. The accumulated water vapor is then measured and a calculation made as to permeation per unit of time. One main advantage of the accumulated method is that minimum vapor detection is limited only by the ability to produce a good seal around the edges of the plastic film in the sample cell.

### CROSS-REFERENCE TO RELATED APPLICATIONS

This application claims the benefit of commonly owned U.S. Provisional Application Ser. No. 61/381,827, filed on Sep. 10, 2010 and entitled “SYSTEMS AND METHODS FOR PERMEABILITY TESTING OF BARRIER FILMS USING OPTICAL CAVITY LIGHT DECAY TIMES,” the disclosure of which is incorporated herein by reference.

### TECHNICAL FIELD

This disclosure relates to measuring systems and more specifically to systems and methods for permeation rate testing of barrier films. Even more specifically, this disclosure relates to water vapor permeation rate testing of plastic barrier films with the testing occurring after a steady state has been achieved.

### BACKGROUND OF THE INVENTION

One important characteristic of certain materials, such as plastic barrier films, is the degree to which certain substances, such as gas and vapors, permeate the materials. In certain applications, such as used in photovoltaic devices, low permeability to water vapor results in longer lifetimes and thus contributes to lower cost and better reliability. Water vapor transmission rate (WVTR) is a widely used measurement for determining the barrier properties of a plastic film. It is a measure of the amount of water vapor that can permeate through a certain area of a film over a certain period of time. WVTR is one of the key properties in protective films for photovoltaic, organic light emitting diodes (OLED) and other electronic devices.

In the above-identified provisional patent application there is discloses a system and method that uses cavity ringdown spectroscopy (CRDS) to measure water vapor permeation rate of plastic barrier films. In operation, the cavity ringdown system is arranged on a “flow” detection configuration in which high purity carrier gas is used to transport the water vapor that has permeated through a plastic film towards the CRDS detection system. One advantage of CRDS detection resides in the very long interaction optical path length that allows the detection of very small amounts of water vapor by means of optical absorption.

In essence, the CRDS system will probe the water content present in a given gas flow by measuring the decay time in an optical cavity that uses a laser operating around 1392.5 nm (others resonant wavelengths can also be used, for instance mid-infrared lasers can increase the sensitivity of the CRDS since water exhibits a higher absorption strength in this spectral region) which is resonant to one of the water peak absorption bands. For a given permeation rate, the amount of water detected by the CRDS is a function of both pressure and flow rate. Pressure affects the reading due to the so called Dicke broadening in which the carrying gas will broaden the water absorption peak due to collisional interaction. Flow rate affects the CRDS reading by changing the water content of the carrying gas, the higher the flow rate the lower the water content and therefore the lower the CRDS reading.

Water vapor transmission is usually reported in g/(m²-day) and the CRDS reports the permeation in terms of part per billion per volume (ppbᵥ). Two approaches can be followed to convert ppbᵥ to g/(m²-day): the first approach is a mathematical description that relates ppbᵥ and g/(m²-day). The second approach relies on measuring a group of samples with known permeation rates in g/(m²-day) and building a calibration curve using the readings from the CRDS unit.

Under the best operational conditions, the flow method discussed above is limited by the lowest stable reading in the CRDS system which is around 0.4 ppbᵥ for one particular commercial instrument (other detection limits are possible with a long cavity or with other design changes). At a flow rate of 10 sccm, and a pressure of 10 psi the flow method can comfortably detect down to 5×10⁻⁵ g/(m²-day) of water vapor. However, plastic films used in some current and future applications (for instance in organic light emitting diodes (OLEDs)) must exhibit permeation rate lower than 1×10⁻⁶ g/(m²-day).

Therefore, there exists a need for a gas permeation measurement technique having the ability to analyze for a specific molecule such as water at permeation rates in the range of 1×10⁻⁶ g/(m²-day).

### BRIEF SUMMARY OF THE INVENTION

The present invention is directed to systems and methods which utilize a wavelength-tuned cavity ringdown spectroscopy (CRDS) technique for measuring vapor transmission rate through a barrier film by first allowing the vapor to accumulate over a period of time after a steady state condition has been achieved. In this manner, in one embodiment, water permeation through a plastic film, even at very low permeation rates, can be accumulated over time. The accumulated water vapor is then measured and a calculation made as to permeation per unit of time. One main advantage of the accumulated method is that minimum vapor detection is limited only by the ability to produce a good seal around the edges of the plastic film in the sample cell.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of a diagram of a permeation cell with CRDS apparatus;

FIG. 2A shows another embodiment of the concepts discussed with respect to FIG. 1;

FIG. 2B shows the decay curve using the apparatus of FIG. 2A;

FIG. 3 shows the effects of both pressure and flow rate on CRDS measurements;

FIG. 4 shows a calibration curve using films with known permeation;

FIG. 5 shows one embodiment of a schematic diagram of an accumulation system; and

FIG. 6 shows one embodiment of a method of operation in accordance with aspects of the invention.

### DETAILED DESCRIPTION OF THE INVENTION

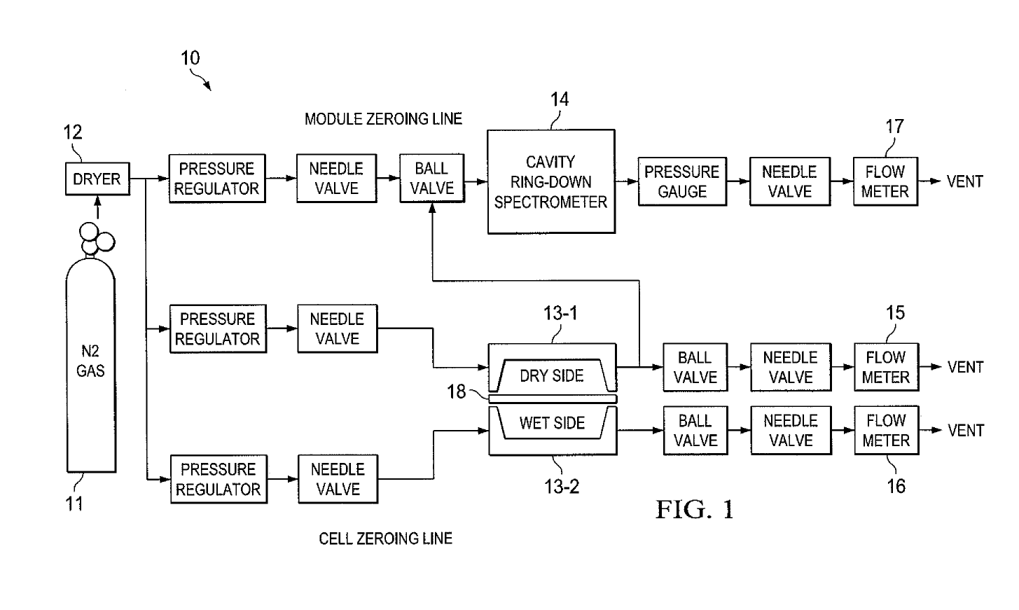

FIG. 1 shows one embodiment 10 of a diagram of a permeation cell with CRDS apparatus. The operation of FIG. 1 is explained in more detail in the above-identified provisional application in that drying agent 11 (in this example high purity gas N₂ or any other carrier gas) along with dryer 12 serves to dry the system. Water (or another substance such as oxygen or carbon dioxide, or other vapors) may be passed to the wet side of film 18 or a volume of moisture may be contained on the wet side of the chamber in chamber 13-2. This can be accomplished, for example, by using a wet sponge. Dry air (or other transport mechanism) passes through chamber 13-1 and then the vapor or other analyte that permeates through film 18 from wet side 13-2 to dry side 13-1 is passed into CRDS 14 and the amount of vapor is measured. Flow meters 15, 16 and 17 keep track of the respective vapor flows.

As discussed, the advantages of using the CRDS for WVTR measurement resides in the very long interaction path lengths through the water vapor volume which enhance sensitivity compared to non-dispersive spectroscopy techniques such as Fourier Transform Infrared Spectroscopy. Compared to a system which measures light intensity, the CRDS measures decay time with a very long interaction optical path.

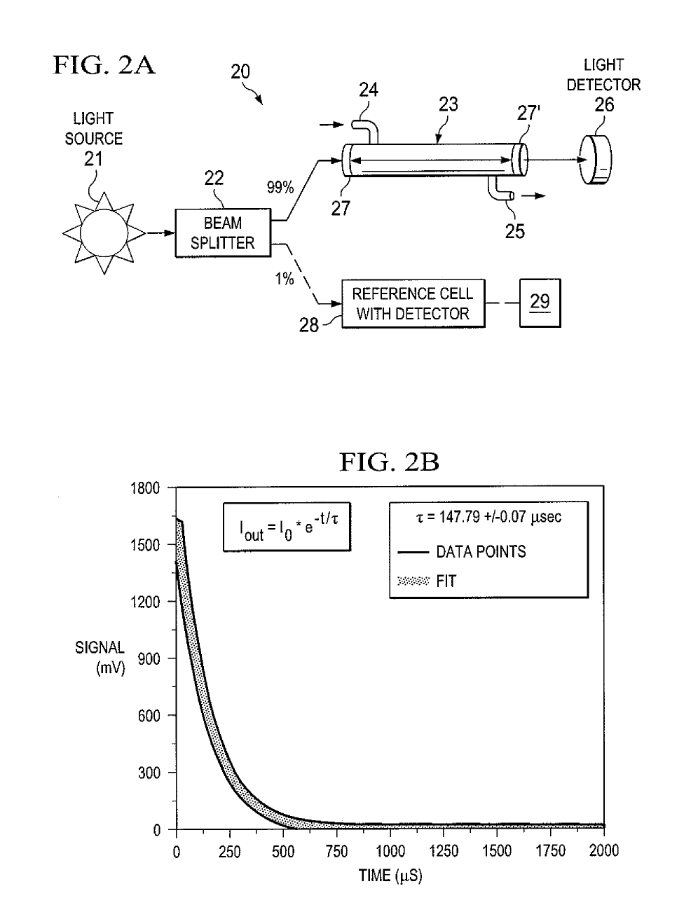

FIG. 2A shows another embodiment 20 of the concepts discussed herein. In this embodiment, the light wavelength is tuned to match the water vapor absorption (around 1392.5 nm). Light within the chamber forms an optical cavity by use of high reflective minors 27 and 27′ in the well-known manner. The system uses fast electronics to measure the decay time within optical cavity 23 as the light leaving the chamber impacts upon detector 26. This then allows for the calculation of the water contents in ppbᵥ using the set of equations presented in table 1. FIG. 2B shows a representative decay curve that may be obtained from the system of FIG. 2A.

Note that in some situations, as discussed above, different analyst (vapors) may be present and the laser (or other collimated energy source) can be frequency tuned to resonate with a selected analyte. This tuning can be changed from time to time (even during the measurement of a given sample) to allow the system to provide measurements for different vapors, if desired.

Useful equations used to determine water vapor content through CRDS:

TABLE 1
Optical equations in Cavity Ringdown Spectroscopy

| | |
|---|---|
| First Measurement: | ${τ}_{zero} = \frac{d}{c ( 1 - R )} No gas in cavity$ |
| Second Measurement: | $τ ( v ) = \frac{d}{c ( 1 - R + σ ( v ) N d )} Gas in cavity$ |
| Calculate Content: | $N = \frac{1}{c σ ( v )} ( \frac{1}{τ ( v )} - \frac{1}{{τ}_{zero}} )$ |

c—speed of light
d—cell length
R—reflectivity of mirror
N—molecular density (content)
σ—absorption cross section
τ—ring-down time
v—laser frequency

The vapor to be measured is input to the chamber via inlet 24 and removed via outlet 25. Light source 21 is a laser light tuned to the desired frequency. A portion (in the example, 99%) of the light is sent to test chamber 23, while a portion is sent to reference cell 28 for detection by detector 29. Accurate wavelength control is preferred to ensure that the wavelength of the light source matches the specific water absorption band for a resonant condition. Therefore, the emission wavelength of the light source needs to be measured constantly. For instance, changes in temperature of the laser diode that is used as light source, can shift the emission wavelength (by modifying the effective index of refraction of the laser structure) of the laser, detuning it from the resonant condition. One way to ensure constant operation at the resonant wavelength is to add a reference cell (containing water) with detector 29 as presented in FIG. 2A. If the wavelength coming from the laser source matches the resonant absorption of the water contained in the reference cell, no light or very little light will reach the detector, and resonant operation will be ensured.

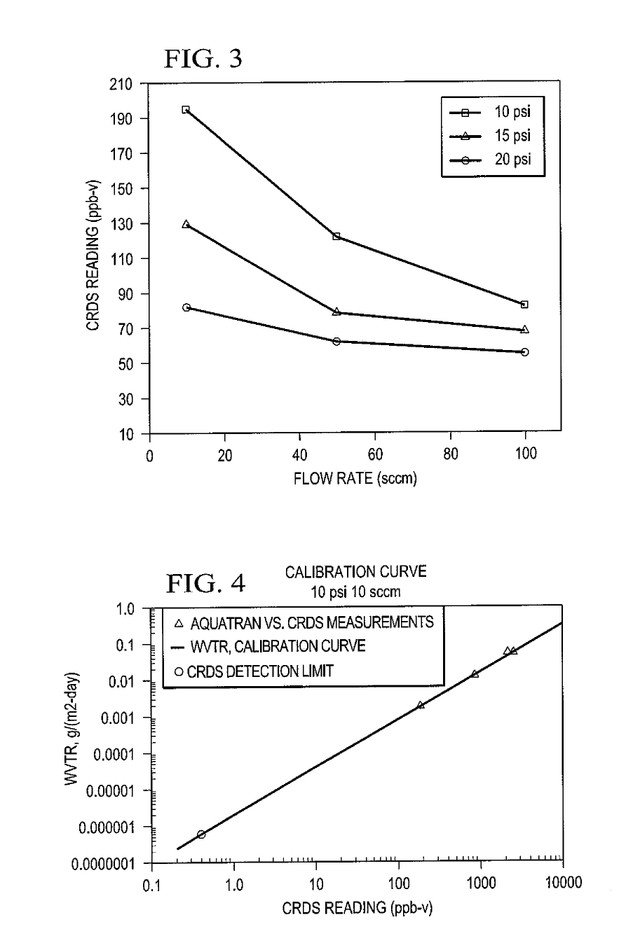

FIG. 3 shows the effects of both pressure and flow rate on CRDS measurement readings when used to measure the water vapor transmission rate (WVTR) through a plastic barrier film with a WVTR of 10⁻³ g/(m²-day). Water vapor transmission is usually reported in g/(m²-day) and the CRDS reports the permeation in terms of parts per billion per volume (ppbᵥ). Two approaches can be followed to convert ppbᵥ to g/(m²-day). The first approach is a mathematical description that relates ppbᵥ and g/(m²-day). The second approach relies on measuring a group of samples with known permeation rates in g/(m²-day) and building a calibration curve using the readings from the CRDS unit.

FIG. 4 shows the development of a calibration curve using the CRDS readings from samples with known permeation. Note that in order to build the calibration curve, a given pressure and flow rate must be chosen. The “flow” detection configuration develops around the best operation conditions in terms of pressure, temperature and flow rate so as to ensure the highest accuracy and lowest detection limit.

Accumulation Method

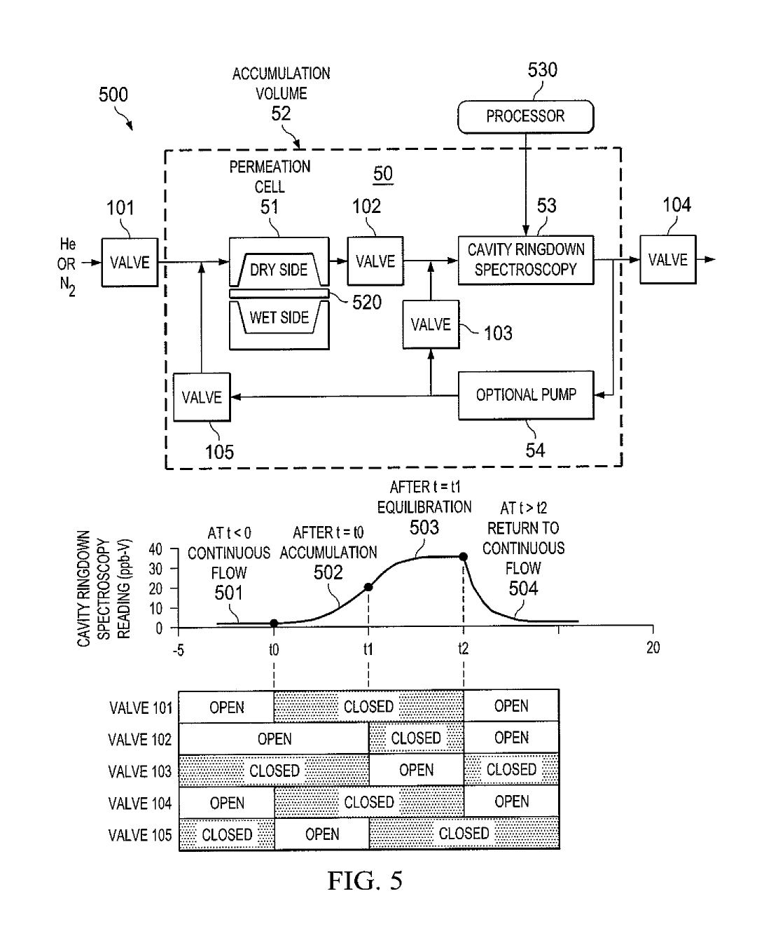

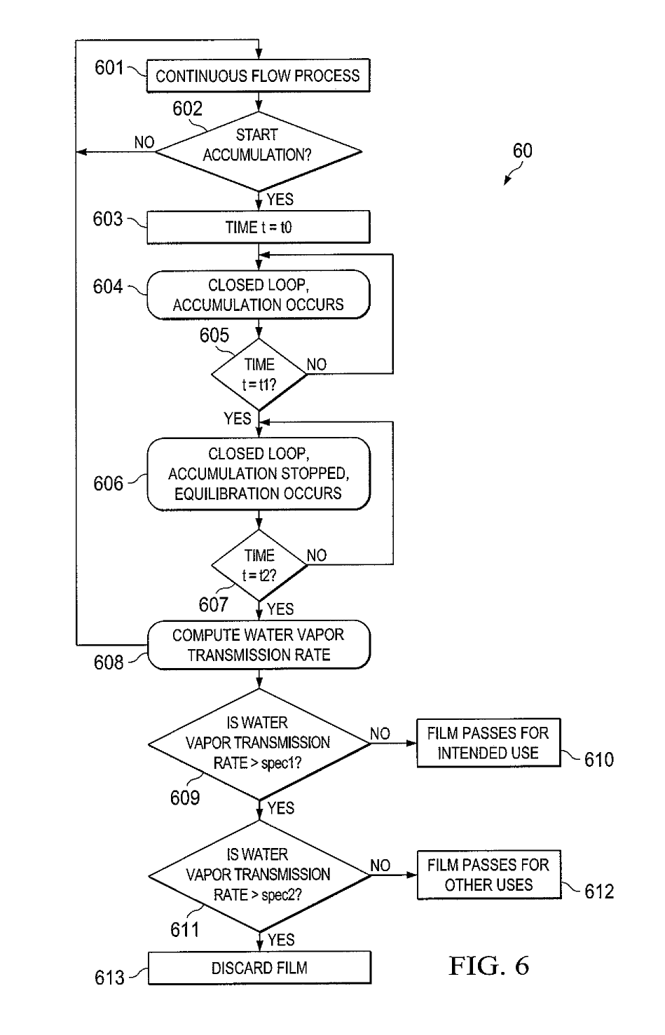

FIG. 5, along with FIG. 6 shows one embodiment 50 of a schematic diagram of an accumulation system, together with graph 500, in accordance with the concepts of the invention. The accumulation system and method shown and described with respect to FIG. 5 is preferably used for permeation rates from 1×10⁻⁶ g/(m²-day) and lower. In the accumulation method, the water permeation of a plastic film is determined by measuring the accumulated water vapor transmission per unit of time (accumulated) instead of instantaneous measurements of the water content in a flow of carrier gas as in the flow method.

In operation, at time t<t0, the system works as in the flow method with valves 101, 102 and 104 open and valves 103 and 105 closed. This step is used to prepare the CRDS for measurements by mainly flowing high purity gas (He or N₂, for example) into the system. This gas should not contain water (or any other gas) that has an absorption band overlapping water vapor (or other gas) being monitored. This is controlled by process 601 of method 60 (FIG. 6). Method 60 can be achieved using code-controlled applications running one or more processors, such as on processor 530, FIG. 5 or can be actuated manually. Input gas flows through value 101 into permeation cell 51 and out through valve 102 to form an accumulation volume 52 which is essentially the piping of system 50. Where the volume fills with a gas, the excess will escape via valve 104 after passing through CRDS 53. In the embodiment shown, the accumulation volume is understood to be the entire circulation volume contained within the system between valve 101 and valve 104, including the CRDS, the permeation cell and optional pump 54. This allows for monitoring the initial value before the accumulation process begins.

Process 602 (FIG. 6) determines when t<0 ends and when t=0 process 603 begins. This would typically be based upon evaluation of the CRDS reading during the continuous flow method and the value is below or close to the lower detection limit of the CRDS the accumulation phase will begin.

At t=0, input valve 101 and output valve 104 are closed and feedback valve 105 is opened. This step prevents new gas from entering or accumulated gas from leaving the now closed loop. Moisture will accumulate in this closed loop as it permeates through sample film 520 in permeation cell 51. Between t=t0 and t=t1, under control of processes 604, water vapor is permeating form the we side through film 520 and is accumulating around the dry side of permeation cell 51. However, it is important that the water vapor diffuses towards the CRDS detector, this can be accomplished by simple diffusion from the permeation cell having high water vapor content to the CRDS detector where the initial water vapor content is lower or by the help of option pump 54, that can help to reach a steady state content of water vapor in volume 52 faster. Processes 604 continues until process 605 determines when time t=t1. This decision would typically be based upon a predetermined fixed time for accumulation (t1−t0) or may be determined based upon the CRDS reading a desired value at t1.

At time t=t1, valve 103 opens and valves 102 and 105 close. Now, as controlled by process 606, no more moisture will accumulate since permeation cell 51 is now isolated from accumulation volume 52. While the total accumulation volume is reduced a small amount, due to the isolation of cell 51, the effect is not considered significant to the measurement. Preferably, this excluded volume is kept to a minimum or accounted for by calibration curves from known samples. During the accumulation period beginning at time t=t1, the moisture in the accumulation volume and within the cavity of the CRDS will begin to equilibrate, resulting in a steady reading of moisture content. The time to reach equilibration will depend upon the volume and length of the accumulation volume, the gas diffusivity, and moisture adsorptivity of the accumulation volume wall materials. The time may be reduced by the use of option pump 54.

Processes 606 and 607 determine when time t=t2. This is typically based upon numerical evidence indicating that the CRDS reading of moisture content has reached a steady value, such as the reading changing less than 1% over a 10-minute period. In one embodiment, t2 is at least 1 hour.

Once the reading is steady, the water vapor transmission rate (WVTR) can be computed under control of process 608. Theoretically, WVTR is equal to the product of the moisture content measured at time t2 (X_{H2O}) and the accumulation volume (V) divided by the product of the test film area (A) and the time of accumulation (t1−t0). This can be represented mathematically as in the following equation:

$$WVTR [ \frac{g}{{m}^{2} - day} ] = \frac{{X}_{{H}_{2} O} [ \frac{g}{{m}^{3}} ] * V [ {m}^{3} ]}{A [ {m}^{2} ] * ( t 1 - t 0 ) [ day ]}$$

For example, if the measurement was conducted with the continuous flow method at pressure of 10 PSI, 10 sccm and temperature of 300K with a test film having a WVTR value of 1×10⁻⁶ g/m²/day using a film area of 50 cm², the test would result in a CRDS reading of only 0.3 ppbᵥ (or 3×10⁻⁷ g/m³) which is below the detection limit of the instrument. However, using the method (process 60) described above with an accumulation volume V=40 mL and an accumulation time (t1−t0)=2 hours, the resulting CRDS reading would be 10 ppbᵥ (or 1×10⁻⁵ g/m³) which is easily measured. Other accumulation volumes or times are possible depending upon the range of the WVTR to be measured. Note that the actual WVTR may vary slightly from the theoretical value if the walls of the accumulation volume have significant moisture adsorptivity. To help reduce the water adsorbed by the tubing walls of the accumulation volume, PTFE coatings or other highly hydrophobic materials can be used to coat the tubing walls. In such cases, the method can be calibrated by measuring films with known values of WVTR and developing a calibration curve. When time t=t2, measurements are completed and valves 101, 102 and 104 are opened and valve 103 is closed effectively returning the system to the continuous flow measurement condition.

Gas flow to the wet side is not required during the accumulation measurement. The purpose of the gas flow to the wet side is to balance the pressure above and below the film during the continuous flow measurement and presumably, the pressures have already balanced above and below the test film during the continuous flow process (at time t1<t0). The gas flow to the wet side may continue or it may shut off at time t0. Either way does not affect the accumulation measurement so long as the pressure remains balance.

Note that the above-described accumulation method can reduce the testing time of films by screening samples, for example, by measuring the slope (502, FIG. 5) of permeation curve 500, before steady state (t=t2) has been reached. This then can be used to infer permeation properties of the films.

Continuing in FIG. 6, processes 609 through 613 illustrate one embodiment of using a CRDS to pass/fail a particular film under test after the permeated gas has had time to accumulate. Note that once the vapor has accumulated, any system can be used to measure the permeability of the film to the applied substance. In this embodiment, process 60 uses a CRDS technique to measurement moisture content as described above. Process 609 determines if the WVTR is greater than a specification required for a particular application (Spec 1). If it is, then the film has failed the test. However, if the WVTR is not greater than the specification then process 610 determines that the film has passed.

In a pass/no-pass system, the testing is finished. Optionally, even if the film fails for one purpose it might be acceptable for another purpose. In this regard, process 611 determines if the WVTR is above a second specification (Spec 2) required for other applications. If so, the film is discarded by process 613. If not, process 612 allows the film to be used for other purposes. Multi-levels can be used to “grade” the film.

In some embodiments, the light wavelength can be tuned to match one of the water vapor (or other measured gas) absorption bands (for instance 1392.5 nm). Light within the chamber forms an optical cavity by use of high reflective minors 27 and 27′ in the well-known manner. The system uses fast electronics to measure the decay time within the optical cavity as the light leaving the chamber impacts upon a detector. This then allows for the calculation of the water content in ppbᵥ using the set of equations presented in Table 1.

Note that in some situations, different gas vapors may be measured for permeability through a substance and when this is done the laser (or other collimated energy source) can be frequency tuned to resonate with the selected vapor. This tuning can be changed from time to time (even during the measurement of a given sample) to allow the system to provide measurements for different vapors, if desired. For water vapor, tuning could be, for example, 1392.5 nm, 2900 nm, 1950 nm, and 1450 nm, other analyte vapors could be, for example, CO₂ and O₂. For CO₂, the tuning could be 4.3 um, 2.7 um, 2 um, 1.6 um, 1.4 um. For O₂, the tuning could be 0.7596 um, 1.58 um, 1.27 um, 1.06 um, 0.69 um, 0.63 um. The carrier gas can be selected from the list of nitrogen, helium, argon, neon, xenon, krypton or air.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of determining a permeation rate of a material to a substance; said substance impacting said material on a first surface and said measurement being a rate of movement of said substance through said material due to permeation of said substance through said material, said method comprising:
accumulating a sampling of said substance from said second surface of said material; and
measuring an amount of said substance in said sampling.

2. The method of claim 1 wherein said accumulating is performed for at least 1 hour.

3. The method of claim 1 wherein said measuring comprises:
placing at least a portion of said accumulated sampling in an optical cavity; and
measuring a decay time of certain energy applied to said cavity against a known time of decay of said energy in an absence of said second surface substance.

4. The method of claim 3 wherein a wavelength of said certain energy is tuned to resonate with said second surface substance within said cavity.

5. The method of claim 4 wherein said certain energy is wave energy created by a laser.

6. The method of claim 4 wherein said cavity is part of a cavity ring-down spectroscopy technique.

7. The method of claim 1 wherein said substance is water vapor, and wherein said tuning is at a wavelength selected from the following:
1392.5 nm, 1450 nm, 1950 nm, 2900 nm.

8. The method of claim 1 wherein said accumulating is accomplished in a volume having its wall coated to prevent adsorption of said substance.

9. A system for measuring vapor permeation rate through a film from a first surface to a second surface, said film having said first surface exposed to a vapor, said system comprising;
a permeation cell for allowing vapor from an input surface of a film to pass through said film to an output surface of said film;
an accumulation space for accumulating over time vapor from said output surface of said film; and
a measuring device for measuring vapor content of vapor accumulated over time in said accumulation space.

10. The system of claim 9 wherein said measuring device comprises:
an optical cavity; and
a wave energy generator for generating energy for insertion into said cavity, said energy having a first decay time in the absence of measurable vapor and a measurable changed decay time in the presence of said vapor.

11. The system of claim 10 further comprising;
means for determining vapor content based upon said measured decay time.

12. The system of claim 10 further comprising:
a pass/fail detector for determining acceptance in real-time of a film based upon said measured decay time.

13. The system of claim 10 wherein said wave energy generator is tuned to resonate with said vapor.

14. The system of claim 13 wherein said generator is tuned to a wavelength selected approximately from:
1392.5 nm, 1450 nm, 195 nm, 2900 nm.

15. The system of claim 10 wherein said vapor is selected from: water vapor, oxygen, carbon dioxide.

16. The system of claim 9 further comprising:
means for using gas as a carrier for said sampling of said vapor; and
means for removing unwanted moisture content from said gas.

17. The system of claim 16 wherein said gas is selected from the list of:
nitrogen, helium, argon, neon, xenon, krypton, air.

18. The system of claim 9 wherein said accumulating space is substantially free of vapor adsorption.

19. The system of claim 9 wherein said accumulating space comprises at least some walls coated with hydrophobic material.

20. A method of performing permeation rate testing of a film, said method comprising:
supplying a dry carrier gas to a film to be tested, said film being within a permeation cell, said gas being supplied with relatively equal pressure and flow rates to both a dry and wet side of said film;
exposing said wet side of said film to a vapor;
preventing all vapors and carrier gases from entering said permeation cell on said dry side for a period of time;
accumulating all vapors in said dry side of permeation cell for said period of time; and
contemporaneously with a conclusion of said period of time, and before any said vapors or gases from outside said dry side of said permeation cell can contaminate accumulated vapors within said dry side of said permeation cell, passing said accumulated vapors to determine vapor content.

21. The method of claim 20 wherein said vapor content determining comprises:
passing at least some of said accumulated vapors into a cavity;
introducing an energy beam into said cavity for a determined period of time such that said beam resonates within said cavity; and
determining an amount of permeated vapor by measuring a decay time of said energy beam after said determined time has passed.

22. The method of claim 21 further comprising:
adjusting said determining to take into account vapor within said cavity from sources other than permeation through said film.

23. A test apparatus for performing permeation testing of a film, said apparatus comprising:
a permeation cell;
an accumulation space
means for supplying a dry carrier gas to a film contained within said cell, said gas being supplied to both a dry and wet side of said film;
means for exposing said wet side of said film to a vapor;
means after a first period of time for sealing a dry side of said permeation cell and said accumulation space from being further exposed to both said vapor and said carrier gas; and
means after a second period of time for determining vapor content in said accumulation space.

24. The apparatus of claim 23 wherein said vapor is selected from the list of: water vapor, oxygen, carbon dioxide.

25. The apparatus of claim 23 wherein said second period of time is at least 1 hour.

26. The apparatus of claim 25 further comprising:
means for determining an amount of permeated vapor through said film by measuring a decay time of an energy beam at a completion of a determined time.

27. The apparatus of claim 26 wherein said energy beam is a laser light, said apparatus further comprising:
control for adjusting a frequency of said laser light to an optimal frequency for resonation with an expected permeated vapor.
